(19) United States
(12) Patent Application Publication
(10) Pub. No.: US 2013/0114637 A1
(43) Pub. Date: May 9, 2013

(54) METHOD AND DEVICE FOR OBTAINING AN OPTICAL DISCHARGE IN A GAS

(71) Applicant: Yuri Aleksandrovich Chivel, Minsk (BY)

(72) Inventor: Yuri Aleksandrovich Chivel, Minsk (BY)

(21) Appl. No.: 13/811,373

(22) PCT Filed: Jul. 11, 2011
(86) PCT No.: PCT/IB2011/002842

§ 371 Date: Jan. 21, 2013

(30) Foreign Application Priority Data
Jul. 19, 2010 (RU) 2010130149

(51) Int. Cl. H01S 3/034; H01S 3/03

(52) U.S. Cl. CPC H01S 3/034; H01S 3/03
USPC 372/55

(57) ABSTRACT

The invention relates to the field of laser physics and laser technology and can be used in the development and creation of plasma-chemical systems based on lasers.

A method of obtaining an optical discharge consisting in the optical breakdown of the gas to form a plasma region and maintain it in a laser beam during the duration of its action.

New in the author's opinion is that the breakdown of the gas to form a plasma region and its maintenance is carried out in the laser cavity.

New in the author's opinion is that the breakdown of the gas to form a plasma region and its maintenance is carried out in an additional cavity of three-mirror laser cavity.

New in the author's opinion is that the breakdown of the gas to form a plasma region and its maintenance is carried out in the focal region of a conical laser beam New in the author's opinion is that the breakdown of gas to form a plasma region and its maintenance is carried out in the focal region of the volumetric laser beam.

Device to obtain an optical discharge in the gas, contains a laser, optically coupled to the focusing lens.

New in the author's opinion is that the device further comprises a laser, optically coupled to the focusing lens system forming a ring beam in a reflective axicon and the conical mirror and tapered rotating mirror, the angle of convergence conical beam is 1800.

New in the author's opinion is that the device further comprises a laser which is a set of disk or diode laser segments located on the surface of a sphere centered at the point of intersection of the optical axis.

The invention relates to the field of laser physics and laser technology and can be used in the development and creation of plasma-chemical systems based on lasers.

There is a method [1] of obtaining an optical discharge in a gas consisting of optical breakdown of the gas to form a plasma region and maintain it in a laser beam during the duration of its action.

The disadvantage of this method is the large losses of laser radiation due to high transmittance of laser radiation by laser plasma discharge, 40% and even more on the length of a CO₂ laser, which makes it difficult to use more short-wave lasers. Closest to the proposed method is presented in [2] method of obtaining optical discharge in a gas.

The disadvantage of this method is the complexity of implementation. large losses due to the high transmittance of laser radiation by plasma of optical discharge. The objective of the claimed invention is to extend the application of the optical discharge by using compact laser systems, near-infrared, visible and ultraviolet range and energy efficiency of the laser.

To solve this problem a method for making an optical discharge in a gas consisting of optical breakdown of the gas to form a plasma region and maintain it in a laser beam during the duration of its action.

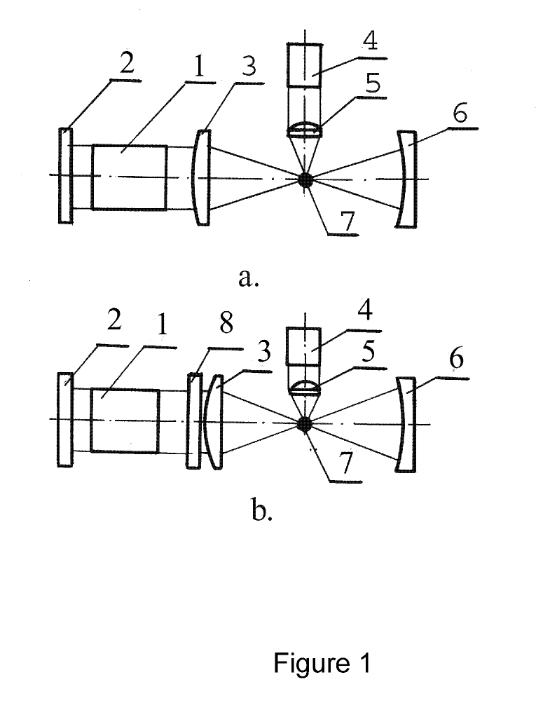

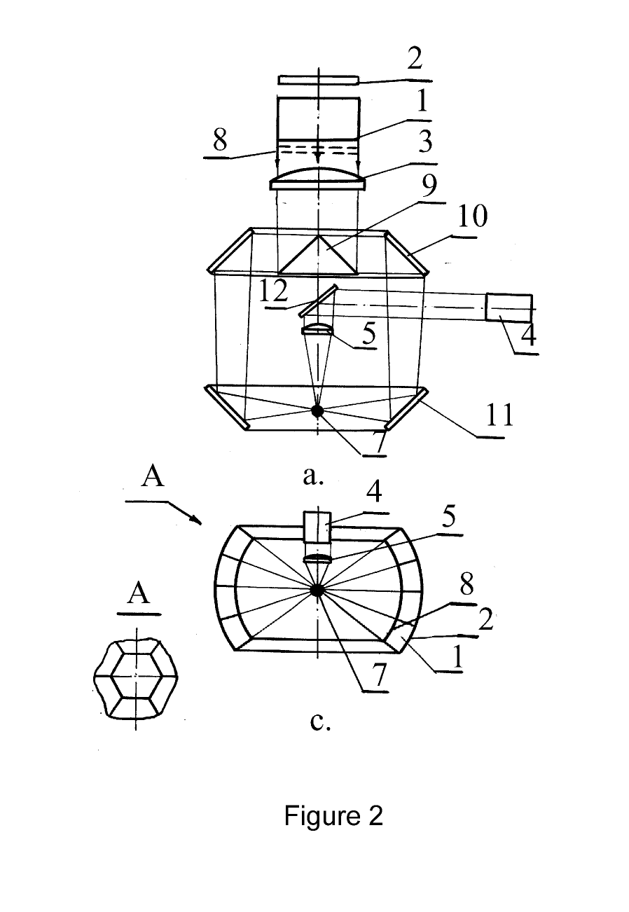

In the present method the breakdown of the gas to form a plasma region and its maintenance is carried out in a concentric cavity of a cw laser or a laser with high pulse duration, designed to maintain the discharge (FIG. 1). Gas breakdown is produced by focusing with lens 5 intensive short laser pulse 4. Due to repeated passage of laser radiation through the plasma region between totally reflected mirrors 2,6 the radiation is completely absorbed regardless of the wavelength of the laser radiation. Due to the low absorption coefficient of the plasma of optical discharge plasma influence on the lasing characteristics of the laser would be insignificant. To reduce them, if necessary, you can use the three-mirror cavity (1b), and locate optical discharge in an additional concentric resonator formed by a semitransparent mirror 8 and totally reflected mirror 6 (FIG. 1b). Symmetrization for optical discharge, as well as enable the application of a set of low-power laser to maintain the optical discharge in the first case the discharge is carried out in the focal region of a focused conical laser beam (FIG. 2a), while in the second case in the focal point of the volumetric laser beam (FIG. .2).

A device [3] for an optical discharge in a gas contains a pulsed Nd-laser, optically coupled to the focusing lens.

A disadvantage of this device is the short wavelength of the laser and the appropriate low absorption of the discharge plasma α˜γ²˜10⁻² cm⁻¹ (air, γ=1,06 mcm) and correspondingly large losses of laser power.

The closest to the technical essence of the proposed device is a device [4] of obtaining an optical discharge in a gas containing a continuous CO₂ laser, optically coupled to the focusing lens.

A disadvantage of this device is the large losses of radiation despite the large CO₂ emission wavelength. In a discharge with a characteristic size of 1 cm about 50% of the laser radiation is absorbed

The objective of the claimed invention is a device which provides complete absorption of the laser radiation.

To solve the problem, the new technical solutions are created

New in the author's opinion is that the device further comprises a laser, optically coupled to the focusing lens system forming a ring beam in a reflective axicon and the conical mirror and tapered rotating mirror, the angle of convergence conical beam is 180°.

New in the author's opinion is that the device further comprises a laser which is a set of disk or diode laser segments located on the surface of a sphere centered at the point of intersection of the optical axis.

The essence of the invention is illustrated by drawings, which show general views of the proposed device (FIG. 2 a, b).

The device (FIG. 2a) comprises a laser active element 1, mirror 2, lens 3, reflective axicon 9, rotary conical mirrors 10,11, a powerful short-pulse laser 4, rotating mirror 12, lens 5. The optical system of the axicon 9 and rotating conical mirrors 10, 11 is equivalent to a fully reflected mirror.

The device operates as follows. Short powerful laser pulse 4 creates an optical breakdown of the gas in the focus of the lens 5, which coincides with the focus lens 3 in the focal region of conical beam. Emerged optical discharge 7 is maintained by absorption of the radiation of the laser 1 at multiple radiation passes through a continuous discharge. This device can be realized by a circuit of 2 mirror cavity and 3-mirror cavity by installing translucent mirror 8.

Device (FIG. 2c) contains a laser to ignite the optical discharge 4, a set of laser segments consisting of one active element with spherical mirrors 2, 8, placed on the field. Each pair of opposed laser segments form either 2 or 4 mirrors coaxial cavity. The device operates as follows. Short powerful pulses of laser 4 with a lens 5 creates optical breakdown of the gas in the focal volume of the beam generated by the laser diffraction communication segments. Emerged optical discharge 7 is supported by the absorption of laser radiation in multiple segments of the radiation passes through the discharge. Capacity of the entire set of laser segments will be fully pumped into the optical discharge and compensate for the thermal conductivity, and radiative losses discharge.

Thus the inventive method and device can significantly extend the scope of the optical discharge by using compact laser systems, near-IR, visible and UV range and increase the energy efficiency of the laser.

### REFERENCES

1. F. Bunkin, V. Konov, Prokhorov//JETP Lett. V.9. S. 599. 1964.
2. S. Metev, A. Stephen et al.//Riken Review. Number 50. pp. 47-52. 2003.
3. Bufetov, A. Prokhorov, Fedorov, V. Fomin//Proceedings of the GPI. T.10.S.3-70. 1988
4. V. Konov, S. Corner//Sq. electric. T.25.S.291-292. 1998.

1. Method of obtaining an optical discharge in a gas consisting of optical breakdown of the gas to form a plasma region and maintain it in a laser beam during the duration of its action, characterized in that the breakdown of the gas to form a plasma region and its maintenance is carried out in the laser cavity.

2. The method according to claim 1, characterized in that the formation of a plasma region and its maintenance is carried out in an additional cavity of three-mirror laser cavity.

3. The method according to claim 1, characterized in that the formation of a plasma region and its maintenance is carried out in the focal region of a conical laser beam .

4. The method according to claim 1 wherein the formation of a plasma region and its maintenance is carried out in the focal region of a volumetric laser beam.

5. Device to obtain an optical discharge in a gas containing a laser, optically coupled to the focusing lens characterized in that it further comprises a laser, optically coupled to the focusing lens system forming a ring beam in a reflective axicon and the conical mirror and rotating conical mirror, the angle converging conical beam is 1800.

6. Device to obtain an optical discharge in a gas containing a laser, optically coupled to the focusing lens characterized in that it further comprises a laser, which is a set of disk or diode laser segments located on the surface of a sphere centered at the point of intersection of the optical axis.
